(19) United States
(12) Patent Application Publication
(10) Pub. No.: US 2012/0246874 A1
(43) Pub. Date: Oct. 4, 2012

(54) COMPONENTS DESIGNED TO BE LOAD-ADAPTIVE

(75) Inventor: Michael Dienst, Berlin (DE)

(73) Assignee: BEUTH HOCHSCHULE FUR TECHNIK BERLIN, Berlin (DE)

(21) Appl. No.: 13/517,181

(22) PCT Filed: Dec. 17, 2010
(86) PCT No.: PCT/DE10/75164

§ 371 Date: Jun. 19, 2012

(30) Foreign Application Priority Data
Dec. 21, 2009 (DE) 102009059246.6-12

(51) Int. Cl. E05D 3/14; E05F 1/12

(52) U.S. Cl. 16/302

(57) ABSTRACT

A load-adaptive component includes at least one trapezoidal, elastically movable four-bar hinge incorporated integrally into the component to generate a shape change behavior that is anisotropically resilient-elastic and is directed counter to the direction of action of a force. The four-bar hinges have first recesses for forming hinge points that are produced by weak points in the material and embody elastic bending hinge, and second slot-like recesses connected to or joining the hinge points. A plurality of successive, mutually spaced four-bar hinges form a multi-hinge mechanism integrated into the component.

### CROSS REFERENCE TO RELATED APPLICATIONS

This application is a national stage of PCT International Application No. PCT/DE2010/075164, filed on Dec. 17, 2010, and published in German on Jun. 30, 2011 as WO 2011/076202 A1, which claims priority to German Patent Application No. 10 2009 059 246.6-12 filed on Dec. 21, 2009, the entire disclosures of which are incorporated herein by reference.

### DESCRIPTION

The invention relates to components designed to be load-adaptive, which adapt themselves to punctual, linear, or planar—one-sided or reciprocal—loads or fluidic incident flow conditions.

Structural elements are used in greatly varying fields of technology, which are deformed under load and whose resilient-elastic, conventional deformation behavior as a result of a force action correlates with the direction of the force acting on the relevant component. In the case of specific design requirements, for example, in vehicle and continuous flow machine engineering, and in apparatus engineering, however, it is desirable for a shape change of the component to be achieved opposite to the force action direction. Such a paradoxical behavior—which is not uniquely resilient-elastic—between the impingement direction and the shape change of the component resulting therefrom is advantageous in particular if the handling and operating reliability can thus be improved, for example, in the case of valves and handles of vehicles and manufacturing machines or also in the case of body support surfaces in medical apparatus engineering. The impingement of the component can be one-sided or reciprocal and the system response can be asymmetrical or symmetrical.

A paradoxical force action direction-shape change behavior has heretofore only been implementable using complex mechatronic sensor-actuator arrangements and therefore with a correspondingly high control-technology monitoring expenditure and is additionally connected with a high weight and high costs.

In the case of components of water vehicles which are fluidically impinged in the underwater area, which are typically symmetrically designed and are fluidically loaded on both sides, but also in the case of fluid-impinged continuous flow machines and other systems operating in a fluid, the incident flow surfaces or the steering and control surfaces are subjected to a significant mechanical load. The direction of the shape change of the impinged component incident flow surfaces also follows the direction of the load introduction here and results in changed incident flow conditions, which are unfavorable with respect to flow, on the steering and control surfaces. Previous attempts have been made to counteract the change of the incident flow conditions by an elastic-resilient form change which follows the load impingement direction using a substantial control-technology expenditure, which is therefore costly.

### SUMMARY

The invention is based on the object of developing component structures, which are loaded on one side or reciprocally and punctually or linearly, or which have planar load or incident flow, which, while avoiding high control technology expenditure, independently display a shape change behavior which counteracts the load introduction—and is paradoxically resilient-elastic or favorable for flow.

The object is achieved according to the invention by a component structure designed according to the features of Patent claim 1. Advantageous refinements of the invention are the subject matter of the subclaims.

A component designed to be load-adaptive according to the basic idea of the invention comprises at least one trapezoidal, elastically movable four-bar hinge incorporated integrally therein, for generating a shape change behavior of the component which is oriented opposite to the force action direction and is anisotropically resilient-elastic. The elastic four-bar hinges are an intrinsic part of the component or the component material. The four-bar hinges consist of first recesses shaped in the component to form hinge points, which embody elastic bending joints and are generated by material weak points, and second, slotted recesses, which are attached to the hinge points or connect them. A plurality of four-bar hinges following one another at intervals represents a multi-joint gearing, which is integrated in the component, i.e., is formed by the component itself or by recesses provided in the component, and which has anisotropic resilient-elastic shape change behavior, without control system expenditure and with little cost expenditure, in the event of a load acting on the component, i.e., has a shape change behavior oriented opposite to the direction of the force acting on the component.

The invention can be applied in components loaded on one side or reciprocally loaded components, which are impinged by a fluid, for example. In a component impinged on both sides or reciprocally, the four-bar hinge has an isosceles, symmetrical trapezoidal shape. Components impinged on one side with a load, in contrast, have a multi-joint gearing made of successive four-bar hinges in the form of a non-isosceles, asymmetrical trapezoid.

In a specific embodiment variant—for example, for the side walls of water vehicles impinged by a fluid—the component is manufactured in shell construction and comprises core strips arranged at intervals between two outer side panels to form the second recesses. The first recesses provided to form the elastic hinge joints or hinge points are, in the second recess remaining between each two core strips, respectively opposing grooved inner and outer recesses shaped on the inner side and on the fluid-impinged outer side of the side panels. The grooved recesses are shaped into the side panels in a component having reciprocal fluid impingement in such a manner that the elastic hinge joints formed by the recesses are arranged in the form of a symmetrical trapezoid. Because of this feature combination, the component, for example, a tail rudder of a motor vehicle, has a shape change behavior which is oriented opposite to the direction of the flow impingement and is advantageous for flow mechanics.

In a further implementation of the invention, a reciprocally punctually or linearly loadable bending component designed in one piece, having symmetrical cross-sectional surface has an outer bore close to the edge and two inner bores offset in the longitudinal direction, which represent the first recesses to form the four elastic hinge joints or hinge points of a symmetrical, trapezoidal elastic four-bar hinge. A further inner bore is provided in parallel to each of the outer bores. The bores functioning as the first recesses are connected to one another or to the upper and lower outer surfaces of the bending component by slotted milled grooves functioning as the second recesses. In this way, elastic four-bar hinges or multi-joint transmissions are formed, which are an integral part of the component and are formed from the component itself and have an anisotropic resilient-elastic shape change behavior oriented opposite to the respective load application direction.

In a further implementation of the invention, a bending component which is loadable on one side having symmetrical cross-sectional surface has one or more four-bar hinges, each designed as an asymmetrical, non-isosceles trapezoid, which comprise two opposing first outer bores as the first recesses and a second outer bore—offset in the longitudinal direction—and two adjacent inner bores, which each form elastic hinge joints or hinge points. A further middle bore is arranged between the first outer bores, the bores being connected to one another or to the outer side of the bending component via second recesses implemented as slotted milled grooves. In the case of one-sided load of a strip-like or bar-like component, through integral incorporation of a four-bar hinge or a multipart four-bar hinge gearing in a girder, a bar, a handle, a contact surface, or the like, a load-adaptive shape change oriented opposite to the load introduction direction can be caused with little expenditure.

In one design of the invention, the shape and size of the first and second recesses and the spacing between the hinge points in the longitudinal and transverse directions of the component are variable as a function of the type and size of the component and the forces acting on the component and the respective material used. The first and second recesses may be produced using arbitrary suitable methods.

Exemplary embodiments of the invention will be explained in greater detail on the basis of the drawing. In the figures:

### BRIEF DESCRIPTION OF THE DRAWINGS

FIG. 1 shows a schematic side view of a water vehicle having a tail rudder, provided for its control, as a reciprocally flow-impinged component;

FIG. 2 shows a sectional view of the tail rudder along line AA in FIG. 1;

FIG. 3 shows a sectional view of a component, designed in one piece as a bar loaded on one side, having integrated multi-joint gearing;

FIG. 4 shows an enlarged view of a four-bar hinge generated by the recesses according to FIG. 3 in the form of a non-isosceles, asymmetrical trapezoid;

FIG. 5 shows a sectional view of a one-piece bar loadable on both sides having symmetrically arranged recesses to form four-bar hinges in the form of isosceles, symmetrical trapezoids; and

FIG. 6 shows an enlarged view of a four-bar hinge according to FIG. 5.

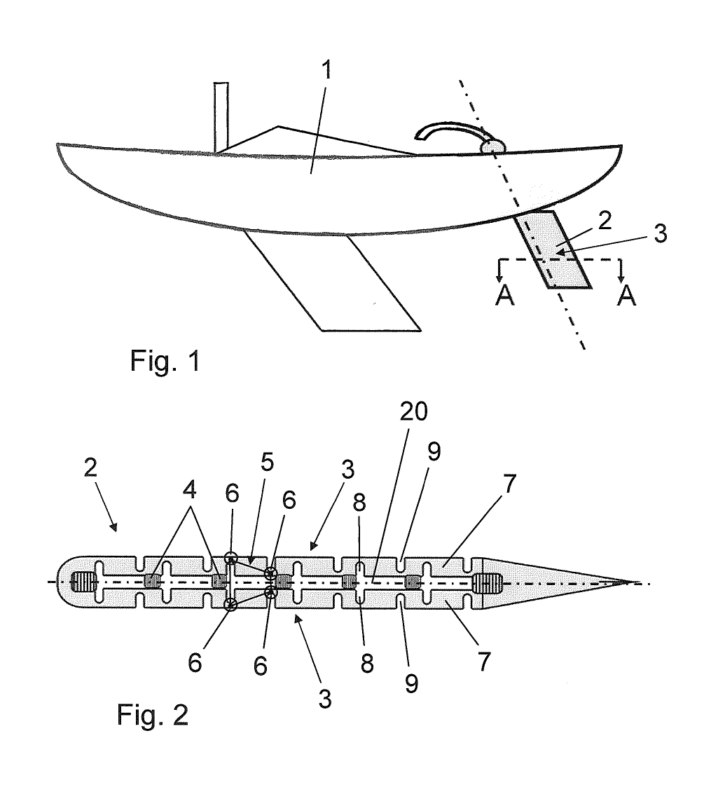

### DETAILED DESCRIPTION

The steering and control surfaces of water vehicles 1, for example, the tail rudder 2, are impinged on both sides by the flowing medium and conventionally deformed in the direction of the respective load introduction, so that the flow conditions on the steering and control surfaces change and flow losses occur. In order to advantageously influence the deformation behavior of the steering and control surfaces 3 on both sides of the tail rudder 2 under load action, the tail rudder 2 comprises multiple four-bar hinges 5, which are in succession in the longitudinal direction and are integrally incorporated in the component structure, whose hinge points 6 are arranged in the component structure in the form of an isosceles, symmetrical trapezoid. The component structure, the tail rudder 2 having lateral steering and control surfaces 3 here, is manufactured in shell construction and comprises two opposing side panels 7, which are connected to one another at the front and rear ends and are spaced apart from one another by multiple core strips 4 arranged at regular intervals. The core strips 4 are implemented as stiff and load-bearing and are materially bonded to the side panels 7. A trapezoidal four-bar hinge 5 provided between each two adjacent core strips 4 is formed by two grooved inner recesses 8 shaped into the side panels 7 and two grooved outer recesses 9 shaped from the outside into the side panels 7. The material weak points remaining on the outer side and on the inner side of the side panels 7 due to the outer and inner recesses 8, 9 each correspond to a hinge point 6 acting as an elastic hinge joint or film hinge joint. The successive four-bar hinges 5 integrated into the component manufactured in shell construction form a multi-joint gearing. In the event of a flow impingement incident on the steering and control surface of the side panels 7, the side panels 7, which assume a neutral symmetrical location in the unloaded state, execute a local elastic buckling movement, which is opposite to the load introduction direction. The component structure, which is implemented here as the tail rudder 2 impinged by flow on both sides, has an anisotropic resilient-elastic shape change behavior, which automatically adapts to the flow conditions and is advantageous for flow mechanics, because of the greater elasticity in the individual joints 6.

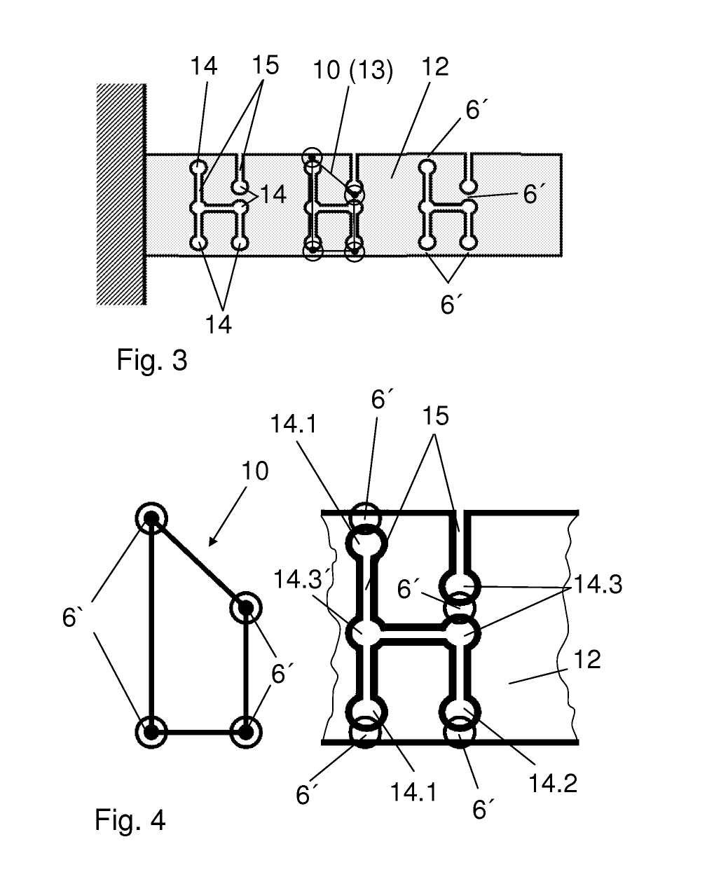

According to FIGS. 3 and 4, the component structure comprises a bending component 12, which is impinged punctually or linearly on one side, in the form of a strip or a bar, a cantilever beam here, having paradoxical deformation, i.e., deformation oriented opposite to the force introduction direction. Such bending components, which do not behave in a uniquely resilient-elastic manner, are advantageously used if the resilient-elastic yielding can result in handling and operating uncertainties in the event of load. As FIGS. 3 and 4 show, the bending component 12 comprises a bar designed in one piece having symmetrical cross section, in which groups of recesses 13 are shaped in succession at intervals, which represent asymmetrical trapezoidal four-bar hinges 10 integrated in the bar. The recesses 13 are formed by bores 14 extending transversely to the longitudinal direction of the bar (bending component 12) and milled grooves 15 (first and second recesses). Two first—outer—bores 14.1 extend close to the edge on the lower side and the load-impinged upper side of the bar. A second outer bore 14.2 runs at a distance from the first bore 14.1 close to the edge on the lower side and two second bores 14.3 and 14.3′ extend parallel to the second bore 14.2 approximately in the middle and at a slight distance one over the other. The bores 14.1, 14.2, and 14.3 are connected to one another via slotted milled grooves 15. The third—upper—bore 14.3′ is attached via a milled groove 15 to the upper side of the bar (bending component 12). The bores 14.1, 14.2, 14.3, and 14.3′ thus arranged in combination with the milled grooves 15 generate material weak points, which each correspond to a hinge point 6′, which functions as an elastic hinge joint or film hinge, of a four-bar hinge 10, designed here as a non-isosceles, asymmetrical trapezoid. The recesses 13 (14, 15) can be produced by machining methods, casting methods, or embossing methods or also other suitable methods. Using a bending component 12 designed in this manner, which functions as a trapezoidal, but non-isosceles, asymmetrical four-bar hinge 10, or with successive four-bar hinges 10 as a multi-joint gearing, while avoiding a substantial control-technology expenditure, a paradoxical, asymmetrical shape change oriented opposite to the force action direction can be achieved, which is variable in accordance with the geometric embodiment of the bending component 12 and the recesses 13 (14, 15) or the four-bar joints 10.

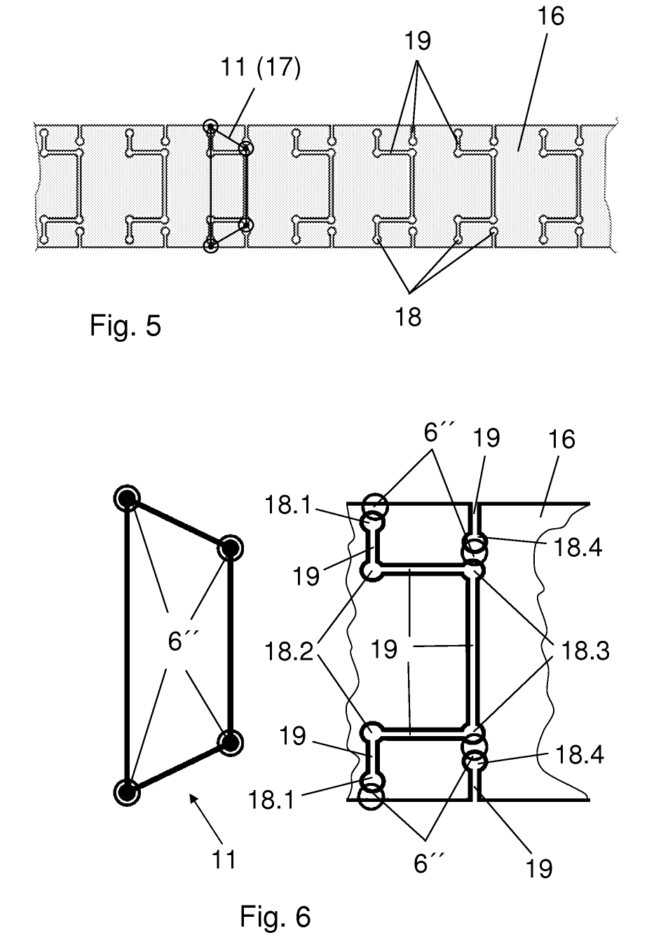

According to a third embodiment variant shown in FIGS. 5 and 6, another one-piece bending component 16, which is designed to be reciprocally load-adaptive, has a bilaterally-symmetrical load deformation regime, i.e., in the event of reciprocal impingement, a symmetrical deformation response opposite to the force introduction direction, i.e., paradoxically resilient-elastic, occurs. The bending component 16, which is shown in the drawing as a one-piece, narrow bar structure having symmetrical cross section, comprises a plurality of trapezoidal four-bar hinges 11, which are formed by successive groups of recesses 17 at intervals and integrally incorporated into the bar structure. Because of the recesses 17, the bending component 16—which is weakened in cross section—has a high elasticity and an anisotropic-elastic shape change behavior. Each four-bar hinge 11, i.e., each group of recesses 17, is formed by bores 18 and milled grooves 19 (first and second recesses) extending in the transverse direction of the bending component 16, which are arranged so that elastic hinge joints or elastic film hinge joints arise through the generation of material weak points, which represent the hinge points 6″ of the four-bar hinge 11. Two outer hinge points 6″ of the four-bar hinge 11 are formed by first—outer—bores 18.1 extending close to the horizontal—upper and lower—lateral surfaces of the bending component 16. Two further—second—bores 18.2 are arranged offset inward to the first bores 18.1 and third bores 18.3 are arranged offset to the second bores 18.2 in the longitudinal direction. The first to third bores 18.1 to 18.3 are connected to one another via the milled grooves 19 (slotted recesses). Finally, fourth—inner—bores 18.4 are arranged in direct proximity to the two third bores 18.3 to form inner elastic hinge joints or inner hinge points 6″. Milled grooves 19 extending to the outer sides originate from the fourth bores 18.4. The inner and outer hinge points 6″ form a four-bar hinge 11 in the form of an isosceles, symmetrical trapezoid. Multiple four-bar joints 11, which are integrated successively at specific intervals in the reciprocally loadable bending component 16, form a multi-joint gearing, through which an elastic deformation oriented opposite to the force introduction direction, i.e., a paradoxical load-deformation regime of the bending component 16, can be implemented.

The invention is not restricted to the above-described exemplary embodiments. Various modifications are conceivable in the scope of the basic idea of the invention, according to which, in a component 2, 12, 16, which is loadable on one side or reciprocally, first and second recesses arranged in a specific manner are provided to form asymmetrical or symmetrical trapezoidal four-bar hinges 5, 10, 11, which are incorporated integrally in the component, or four-bar gearings, and thus deformation behavior of the component oriented opposite to the force introduction direction—and is anisotropic resilient-elastic—is achieved. The components can be implemented in multiple parts—for example, in shell construction—or in one piece—for example, as a bar, strip, or the like. According to the desired deformation behavior and as a function of the component material and the shape and dimensioning of the component, the shape and size of the first and second recesses and the spacing between them can vary both in the same four-bar hinge and also between adjacent four-bar hinges, in order to thus implement a variable anisotropic-elastic deformation behavior, i.e., deformation behavior paradoxically oriented opposite to the force introduction direction.

1. Components designed to be load-adaptive, and elastically adapting to punctual, linear, or planar—one-sided or reciprocal—loads or fluidic incident flow conditions, comprising least one trapezoidal, elastically movable four-bar hinge, which is integrally incorporated into a component, for generating a shape change behavior, which is oriented opposite to a force action direction, and is anisotropic resilient-elastic, for the implementation of which first recesses, to form elastic hinge joints, which are generated by material weak points and embody hinge points of the at least one four-bar hinge, and second recesses, which are attached to the hinge points, are provided, a plurality of successive four-bar hinges at intervals forming a multi-joint gearing.

2. The load-adaptive components according to claim 1, wherein said at least one four-bar hinge has an isosceles, symmetrical trapezoidal shape in a component impinged on both sides or reciprocally.

3. The load-adaptive components according to claim 1, wherein the at least one four-bar hinge has a non-isosceles, asymmetrical trapezoidal shape in a component impinged on one side with a load.

4. The load-adaptive components according to claim 1, further comprising a shell construction, having two side panels and core strips arranged at intervals between them to form the second recesses, for components impinged by a flowing medium, the first recesses, provided to form the elastic hinge joints or hinge points, and the second recess remaining between each two core strips, being grooved inner and outer recesses shaped in pairs on the inner side and on the fluid-impinged outer side of the side panels.

5. The load-adaptive components according to claim 4, wherein said grooved recesses, in the case of reciprocal fluid impingement, are shaped into the side panels in such a manner that the elastic hinge joints formed by the recesses are arranged in the form of a symmetrical trapezoid.

6. The load-adaptive components according to claim 1 further comprising a reciprocally loadable bending component having symmetrical cross-sectional surface, in which an outer bore close to the edge and two inner bores offset in the longitudinal direction respectively represent the first recesses for implementing the four elastic hinge joints or hinge points of a symmetrical trapezoidal, elastic four-bar hinge, a further inner bore being provided parallel to each of the outer bores, and the bores being connected to one another and the inner bores being connected to the upper and lower outer surfaces of the bending component by slotted milled grooves functioning as the second recesses.

7. The load-adaptive components according to claim 1, further comprising a bending component loadable on one side having symmetrical cross-sectional surface, in which a four-bar hinge designed as an asymmetrical, non-isosceles trapezoid comprises, as first recesses, two first outer bores arranged opposite and a second outer bore offset in the longitudinal direction—and two adjacent inner bores, which each form elastic hinge joints or hinge points, a further middle bore being arranged between the first outer bores, and the first outer bores and the inner bores being connected to one another one of the inner bores being connected to the outer side of the bending component via the second recess implemented as a slotted milled groove.

8. The load-adaptive components according to claim 1, wherein a shape and a size of the first and second recesses and the spacing between the hinge points are variable in the longitudinal and transverse directions of the component as a function of a type and a size of the component and the forces acting thereon and the respective material used.

9. The load-adaptive components according to claim 2, further comprising a shell construction, having two side panels and core strips arranged at intervals between them to form the second recesses, for components impinged by a flowing medium, the first recesses, provided to form the elastic hinge joints or hinge points, and the second recess remaining between each two core strips, being grooved inner and outer recesses shaped in pairs on the inner side and on the fluid-impinged outer side of the side panels.

10. The load-adaptive components according to claim 2, further comprising a reciprocally loadable bending component having symmetrical cross-sectional surface, in which an outer bore close to the edge and two inner bores offset in the longitudinal direction respectively represent the first recesses for implementing the four elastic hinge joints or hinge points of a symmetrical trapezoidal, elastic four-bar hinge, a further inner bore being provided parallel to each of the outer bores, and the bores being connected to one another and the inner bores being connected to the upper and lower outer surfaces of the bending component by slotted milled grooves functioning as the second recesses.

11. The load-adaptive components according to claim 2, further comprising a bending component loadable on one side having symmetrical cross-sectional surface, in which a four-bar hinge designed as an asymmetrical, non-isosceles trapezoid comprises, as first recesses, two first outer bores arranged opposite and a second outer bore offset in the longitudinal direction—and two adjacent inner bores, which each form elastic hinge joints or hinge points, a further middle bore being arranged between the first outer bores, and the bores and the bores being connected to one another and the bore being connected to the outer side of the bending component via the second recess implemented as a slotted milled groove.

12. The load-adaptive components according to claim 2, wherein a shape and a size of the first and second recesses and the spacing between the hinge points are variable in the longitudinal and transverse directions of the component as a function of a type and a size of the component and the forces acting thereon and the respective material used.

13. The load-adaptive components according to claim 3, wherein a shape and a size of the first and second recesses and the spacing between the hinge points are variable in the longitudinal and transverse directions of the component as a function of a type and a size of the component and the forces acting thereon and the respective material used.

14. The load-adaptive components according to claim 4, wherein a shape and a size of the first and second recesses and the spacing between the hinge points are variable in the longitudinal and transverse directions of the component as a function of a type and a size of the component and the forces acting thereon and the respective material used.

15. The load-adaptive components according to claim 5, wherein a shape and a size of the first and second recesses and the spacing between the hinge points are variable in the longitudinal and transverse directions of the component as a function of a type and a size of the component and the forces acting thereon and the respective material used.

16. The load-adaptive components according to claim 6, wherein a shape and a size of the first and second recesses and the spacing between the hinge points are variable in the longitudinal and transverse directions of the component as a function of a type and a size of the component and the forces acting thereon and the respective material used.

17. The load-adaptive components according to claim 7, wherein a shape and a size of the first and second recesses and the spacing between the hinge points are variable in the longitudinal and transverse directions of the component as a function of a type and a size of the component and the forces acting thereon and the respective material used.
